(19) United States
(12) Patent Application Publication
(10) Pub. No.: US 2021/0295334 A1
(43) Pub. Date: Sep. 23, 2021

(54) COMMODITY TRADE VALUE TRANSACTION SYSTEM, AND A COMMODITY TRADE VALUE TRANSACTION METHOD

(71) Applicant: Flexi Cash AS, Sandvika (NO)

(72) Inventor: Kay SELJESETH, Bærums Verk (NO)

(73) Assignee: Flexi Cash AS, Sandvika (NO)

(21) Appl. No.: 17/261,054

(22) PCT Filed: Jul. 16, 2019
(86) PCT No.: PCT/NO2019/050153

§ 371 Date: Jan. 18, 2021

(30) Foreign Application Priority Data
Jul. 17, 2018 (NO) 20180996

(51) Int. Cl. G06Q 20/40; G06Q 20/10; G06Q 20/20; G06Q 20/32

(52) U.S. Cl. CPC G06Q 20/405; G06Q 20/4014; G06Q 20/3223; G06Q 20/204; G06Q 20/102

(57) ABSTRACT

The present invention discloses a commodity trade value transaction system and a commodity trade value transaction method that provides alternative payments means to customer purchasing goods.

### TECHNICAL FIELD

The present invention relates to a commodity trade value transaction system, and a commodity trade value transaction method.

### BACKGROUND

In retail stores, customers pay for articles at a manual or automated cash register in the store cash, credit card, debit cards or mobile phone payment systems. Traditionally, when the customers paid using cash, the cashier at the cash register would count the cash, enter the amount into the cash register, calculate the change and dispense change to the customer. The store manager would have to keep track of cash put into the cash register in the morning and repeat the process again in the evening when the cash was returned to a safe for storage. The store manager would also have to transport the cash to a bank for deposit, typically carrying the cash to a night safe. The manual cash handling involved risk of loss, theft, as well as personal injury in case of robbery. To alleviate some of these risks a large business of closed cash handlings systems and armoured cash collection services has emerged. After the cash has reached the bank or cash handling provider, the cash undergoes cash processing where coins are sorted and stacked in coin rolls. The bank or cash-handling provider sell the coin rolls back to the merchant with a surcharge, sometimes even surpassing the value of the coin roll. Cash, and in particular coin, management is a substantial cost for the stores.

Currently any merchant or retailer are expected to return physical change back to any shopper or customer buying services and products from the merchant, and paying with cash. The amount of coins and notes in circulation poses a major environmental problem from the use of metals, cotton, linen and the transportation etc. to support the cash payment to be supported in the society. There is about 6 trillion coins in circulation. This amount of coin can be visualized as 31 stacks of coin reaching to the moon. The CO₂ emissions from the armoured cars transportation of cash worldwide exceeds by far the total CO₂ emissions from all airline traffic in the world.

The customers are changing their preferences for the means of payment and many customers simply want to avoid cash, as electronic means of payment are more convenient and secure. Still, as there is lots of cash in circulation most people receive cash on a regular basis. This cash is a hassle and most people prefer to get rid of the cash at the first possible occasion. In addition, the merchants pay a substantial cost from handling the cash and they are seeking a cash-less payment scenario.

The patent application herein addresses these problems by allowing a major reduction of cash in the society by breaking the cash cycle (pay/receive many times) incurred from any cash that becomes available. Additionally the patent application describes a smart way to control the flow of cash and allows for alternative uses of the change that becomes available from cash purchases.

Today's POS and payment solutions in commodity trade and service industries, including payment “over disk” where bank cards, mobile payments, ID-based payments or other forms of payment are used, have little flexibility, as only one source of funds is associated with the form of payment. Typically, this includes a bank account with or without credit.

This means that customers as payers may end up without coverage for purchases because the funds on affiliated account are limited.

### SUMMARY OF THE INVENTION

According to a first aspect, the invention provides a commodity trade value transaction system, at least comprising:
a) one or more POS-systems (in store),
b) one or more payment terminals, at least configured to communicate with the one or more POS-systems,
c) means of payment,
d) reading means embedded in the one or more payment terminals configured to read means of payment data and optionally means of payment holder data,
e) at least one customer data base,
f) a first processor with processing means and memories (included in the POS) for process of payment data associated with payment data holder and customer data, where the customer data is mapped with payment data holders,
g) a first set rules algorithm run by the first processor,
h) a first decision machine configured to receive first set rules output of first set rules algorithm and further configured to, based on received data, decide further transaction sequences,
i) at least one token/ID-matching server, configured to hold customer data,
j) at least one second processor included in the token/ID-matching server configured to execute a second set rules algorithm,
k) a configurator of the token/ID-matching server is configured to receive output from the second set rules algorithm and based on the received output from the second set rules algorithm to configure further transaction steps,
l) an execution machine configured to interface with the configurator and execute further transaction steps based on the output from the configurator,
m) the execution machine includes at least one second decision machine configured to receive further execution steps from the configurator and configured to receive input data from the customer and further configured to, based on input, to make a choice for means of payment for concluding a commodity value transaction.

According to another aspect of the invention it is disclosed a commodity trade value transaction method at least comprising the steps of:
a) initialising the commodity trade value transaction method at completed registration of commodities to be purchased by a first customer, the initialisation is initiated by:
   i. the first customer communicates a payment process request to a point of sale, POS, or
   ii. a cashier communicates a payment process request to the POS, and
b) the POS initialises an ID step for identification of the first customer,
c) the POS initialises a profile acquisition step, acquiring profile data of the first customer,
d) the POS initialises a payment process where acquired profile data of the first customer together with the final amount due for the commodities to be purchased by the first customer is used as input parameters for the payment process, and
e) the POS initiates a complete sale step.

The ID step for identification of the first customer may further comprise the sub steps of:
bi) POS forwards a Request ID Input message to a payment terminal,
bii) POS simultaneously or substantially simultaneously forwards a message to the customer with a message which invites the customer to show his identity and a message is forwarded to the cashier with a message that invites the customer to show his identity,
biii) the cashier invites the customer to show his identity,
biv) the customer shows his identity to the ID Input of the payment terminal,
bv) the ID Input of the payment terminal sends an ID value to the POS, hence the customer Identity becomes known to the POS.

The POS may simultaneously or substantially simultaneously forward a push message to a display screen visible to the customer with a message that invites the customer to show his identity and a push message is forwarded to a display screen visible to the cashier with a message that invites the customer to show his identity.

The step biv above may at least include one of the following sub steps:
the customer initiates a data exchange between data holding circuitry on a customer bank card and the ID Input of the payment terminal;
the customer initiates a data exchange between customers' mobile phone and the ID Input of the payment terminal;
the customer initiates a data exchange between data holding circuitry on a customer identity card and the ID Input of the payment terminal, and
the customer identifies himself manually to the cashier enters the customer personalia into the POS

The profile acquisition step acquiring profile data of the first customer may further comprise the sub steps of:
ci) at the POS generate a request for customer profiles message;
cii) from the POS forward the request for customer profiles message to a store database holding customer profile registries;
ciii) from the store database generate a customer profile message;
civ) from the store database forward the generated customer profile message to POS;
cv) from the POS generate and send a request for customer profile to a token server;
cvi) at the token server generate a customer profile/payment configuration message;
cvii) at the token server forward the customer profile/payment configuration message to the POS, thereby acquiring profile data of the first customer to the POS. The step ciii) may further include a foregoing step of: at the store database look up match between payload of received customer profile message and registry entries, if match=true, then generate a customer profile message based on content of matched registry entry. The step cvi) may further include the foregoing step of: at the token server look up match between payload of received customer profile message received from POS and registry entries in a token server database, if match=true, then generate a customer profile message based on content of matched registry entry in the token server database and from the token server database return the generated customer profile to the token server and continue with sub step cvii) of claim 14.

In one aspect of the invention the payment process of step d) above may further comprise the sub steps of:
di) at the POS generate a payment request message, the payment request message at least including:
   invitation to the customer for use of highest priority payment means,
   a counter value n=0
   the amount due to be paid=Sₙ₊₁
   Nₙ₊₁=indicator of payment means and its priority number, where N₁ is highest priority payment means,
   the number of payment means available to the customer: NA;
dii) from the POS forward the payment request message to the ID Input of the payment terminal;
diii) from the ID Input of the payment terminal forward the payment request as a payment call to a payment device of the payment terminal;
div) at the payment device of the payment terminal request the customer to accept payment means Nₙ₊₁, if request is not accepted continue at step dviii);
dv) at the payment device of the payment terminal generate a payment result status message based on at least one of the tests T1 and T2:
   T1: is Aₙ₊₁≥Sₙ₊₁;
   T2: is n+1=NA;
   Pₙ₊₁=Aₙ₊₁ if T1=false
   Pₙ₊₁=Sₙ₊₁ if T1=true
   where: Aₙ₊₁=available amount on payment means Nₙ₊₁;
   Pₙ₋₁ is amount to be reserved on payment means Nₙ₊₁
   generate a payment result status message with a payload, where the payload at least include:
   the logical value of T1 and T2;
   the amount reserved, Pₙ₊₁, for later debiting of the payment means;
   values of Aₙ₊₁, Sₙ₊₁ and NA, and priority number of payment means Nₙ₊₁;
dvi) from the payment device of the payment terminal forward the generated payment result status message including the payload to the POS;
dvii) at the POS analysing the payment result status:
   if T1=“true” AND T2=“X” then continue with sub step dx
   if T1=“false” and T2 is “true” then continue with sub step dix);
dviii) at the POS generate a payment request message with updated payload where the updated payload of the payment request message at least includes:
   an updated new counter value: n=n−1
   invitation to the customer for use of a lower priority than previously ranked payment means, Nₙ₊₁,
   an updated amount due to be paid: calculate remaining amount due to be paid: Sₙ₊₁=Sₙ−Pₙ and include the remaining amount due to be paid in the payment request message, then continue with sub step dii);
dix) cashier invites the customer to use cash to settle the remaining amount due to be paid or the POS cancels the commodity trade value transaction and finishes the payment process;
dx) at the POS finishing the payment process.

The step div) may further include a foregoing step of: at the payment device receiving the payment request and forwarding to a display means associated with the payment device an input request to the customer where the input request includes the payment means priority number Nₙ₊₁ and a request to choose or not choose the payment means with the priority number Nₙ₊₁.

Other advantageous features of the present invention will be apparent from the accompanying claims.

### BRIEF DESCRIPTION OF DRAWINGS

Embodiments of the invention will now be described with reference to the following drawings, where:

FIG. 1 shows a flow chart of a transaction method;

FIG. 2 shows a detail A of the flow chart in FIG. 1;

FIG. 3 shows a detail B of the flow chart of FIG. 1

FIG. 4 shows a flow chart of a transaction method taking place after a completed registration in a POS has taken place;

FIG. 5 shows elements in a transaction system;

FIG. 6 shows a sequential diagram of a transaction method in a transaction system;

FIG. 7 shows an example of a declined transaction in a transaction system;

FIG. 8 shows an example of a display device indicating an alternative transaction process;

FIG. 9 shows an example of a display device indicating an alternative transaction process;

FIG. 10 shows an example of a display device indicating an alternative transaction process;

FIG. 11 shows an example of a display device indicating an alternative transaction process;

FIG. 12 shows an example of a display device with text in a transaction system;

FIG. 13 shows an example of a display device with text that invites a user to confirm personal information or to deliver personal information to a transaction system;

FIG. 14 shows an example of a display device with text that invites a user to confirm personal information to a transaction system;

FIG. 15 shows an example of a display device indicating a finalised alternative transaction additionally a printer confirming the alternative transaction is shown;

FIG. 16 shows an example of a display device with text in a transaction system; and

FIG. 17 shows an example of a display device indicating an alternative transaction process.

### DETAILED DESCRIPTION

The present invention will be described with reference to the figures.

The present invention provides transaction solutions that allows a reduction of cash in the society by introducing new and alternative payment means/options.

In retail stores, customers pay for articles at a manual or automated cash register in the store cash, credit card, debit cards or mobile phone payment systems. According to the invention transactions finds place between a customer at a retail store and a point of sale system in the same retail store. The POS on its side has communication means for communicating electronically with servers external to the POS and with the customer.

In the present invention a Central Database Customer Repository is used to describe a shared and centralized customer controlled service, where the customer may define if they want to receive cash change and if they in detail prefer to receive only notes or coins at certain denominations (only $1 for example) when receiving change. For security reasons a preference to never receive more than an upper limit is one of many possible preferences a customer may have. Alternative uses of cash into savings accounts, loyalty programs, lotteries, family member accounts and other receiver accounts or services applicable are also a part of this service.

In addition, the merchants may process the change pay-out as configured in their database information by customer, time of day, payment amount, change amount and by other preferences to optimize their cash management. The store and customer preferences are processed by the POS system to provide a balance of merchant interests and customers interests/preferences.

Today it is not possible to establish a credit or loan in a payment terminal if a customer lacks payment from his primary bank, it is an object of the invention to provide alternative payment solutions to a customer including establishing on site loans or credit.

A Central Database Customer Repository concept presented by the present invention provides solutions where a payment terminal and a POS is designed with new functionality to support payment from sources not available today.

There may be several parameters that indicate that alternative means of payment can be proposed and used:
1. Lack of coverage on account linked to payment means
2. Low balance on account associated with payment means
3. Market requests or other related affiliates
4. Season and promotional sales, for example, may be linked to cash-back purchases or given products or services
5. Withdrawals from loyalty programs and adjust balance for these
6. Information related to the customer's relationship with the outlet, including “CRM” target management
7. The principle is that the customer's preferences/profile or outlets preferences/goals determine the payment method(s) that can be used rather than the payment means associated method determines this
8. The way identification of a customer is done or the payment method
9. Amount of purchase amount.

The list of parameters that may trigger use of alternative payment means is not exhaustive.

If one or more of the parameters 1-9 above matches then the payment terminal, mobile payment app, or other interactive payment systems/entities may suggest alternative forms of payment or solutions. These can be for example:
1. Transfer from another account belonging to the customer's account group
2. Payment using “loyalty points”, gift cards or the like
3. Creation of micro loan/credit on exact payment amount from outlet or other sources
4. Withdraw existing credit funds
5. Loan/credit on a “bulk amount”, which increases the customer's available funds beyond current payment

Other available means or agents that may be made available.

Some of the elements in a commodity transaction system and method according to the present invention will be described below.

Point of Sale (System):

The point of sale system (POS) is normally a software application running in a personal computer or other hardware with a processing unit, random access memory and network access. The point of sale software may also include devices for item registration, such as scales, barcode readers, imaging devices and so on. Further, a payment terminal or other device communicating with external equipment such as mobile phones, using wireless signalling and similar may be considered a part of the POS system.

When a mobile device or external device or technology is used to identify a customer, such devices may also be considered as a part of the POS system in the context of the present invention, as they take part in the payment processing, which is a part of the POS system and checkout process.

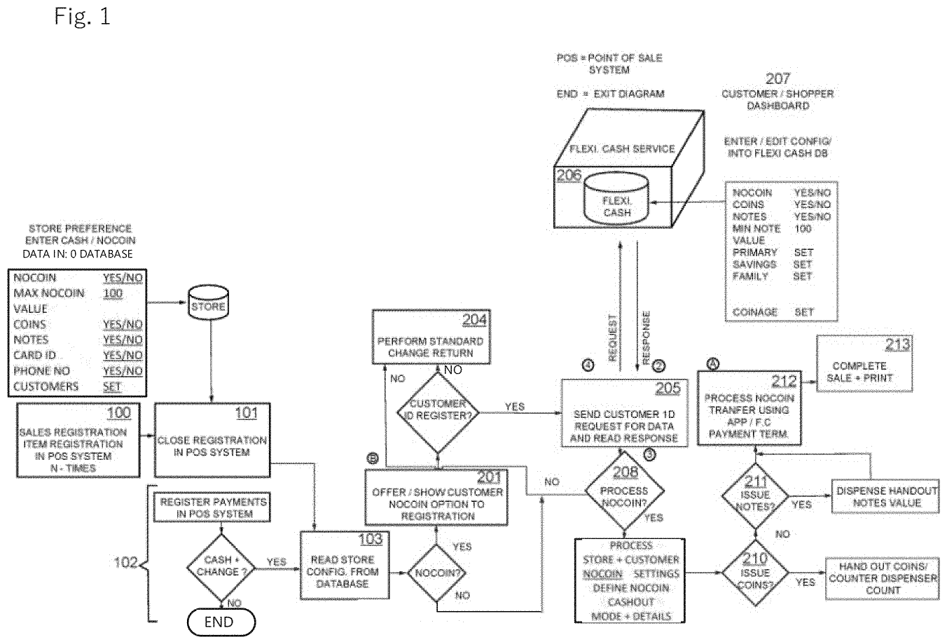

In the following, a Sales Registration as shown in FIG. 1 is described using the reference numbers from said figure.

During this step, the items to be purchased are registered by the cashier and/or customer into the point of sale system. Subtotals, VAT amount and totals are being calculated and summarized.

Close Registration 101:

Whenever all items to be purchased have been registered, the cashier or possibly the customer will decide that no more items to purchased are to be registered and the POS system changes it mode to receive the means of payment.

Register Payments in POS system 102:

Different means of payments may be registered into the POS system, and they will be aggregated into a payment total to equal or exceed the purchase total. If a cash amount is being registered directly by the cashier as it is received manually, or the cash amount is being put into a cash recycler or cash validator, the POS may calculate that a specific amount of cash to be returned is due. If not, the POS system will complete the sale without any actions to return cash (change).

If the customer makes a partial payment with payment card, the POS may read the customer ID from the payment terminal (other device)/card and temporarily store this to be used if a customer also pays with cash requiring a change to be returned.

Read Store Configuration from database 103:

During the POS processing the POS will read the overall POS configuration in order to control its different operating modes. Settings in this configuration may have impact on how the POS process cash received and cash change that is to be returned.

Such setting may be used to control the selections of coins/notes to be returned, if the cashless electronic change mode of operation is allowed and more. If electronic change is set to “off” the POS will control a normal cash return 204.

Offer/show customer Electronic change option by asking for electronic change ID FIG. 3:

Typically the POS will provide the customer a choice to use electronic change by showing a message like “Please register electronic change ID?” to inform the customer of the choice to make. This message can be shown on a fluorescent display or other display means facing the customer. The cashier may also give the same information by verbal or other means of signalling.

The customer may then use any of the implemented methods of 202 identification to identify themselves. Typically, this will include presenting a payment card, a device, a fingerprint or other identifiable measures to the payment terminal or a reader devices connected to the POS system. The registration may also be manual, by for example means of entering the customer phone number into the POS systems using a keypad or keyboard.

Other means such as touch screen input etc. are obvious options to this process.

The ID read will then need to be validated/checked 203.

Customer ID Registration:

The customer may from the preferences decline to use Electronic change and then the normal cash based change pay-out routine is being executed by the POS and the cashier.

Send Customer ID Request for data and read Response 205:

If the customer registers a valid ID, the POS system will use the means of registration ID received and send a request to a central Database Customer Repository 206 ID/Token based central process service.

The ID (and type of ID) together with the merchant ID and the change amount is sent as a request to the central Database Customer Repository service for processing. This service will read the customer preferences (see: Background) 207 and return the cash-out option that the customer prefers together with applicable control information to control the pay-out process, back to the POS system.

The purchased items may be listed and sent to the central Database Customer Repository service as a part of the request mentioned. This information may be used to determine the customer preferences, and may be used to transfer a paperless receipt, aka e-Receipt, to be stored in the Central Database Customer Repository service databases.

Based on the customer's settings, the POS may be directed to not perform an Electronic change pay-out (unlikely) and then the POS continues by executing a normal change pay-out 204.

Process Store+Customer Electronic change settings:

By combining the store/merchant and the customer preferences the POS software program will be able to build a list of pay-out methods and amounts. The methods may be operations to be completed locally by control of the POS system and/or operations to be performed by the central Database Customer Repository service. The process to build the list and give the methods priority are done by normal business logic implemented by programming and best practices learning.

Issue Coins 210:

If the methods of change pay-out (previous paragraph) includes the return of one or more coins, the cashier or a cash recycler typically will give or provide the coins to the customer.

Issue Notes 211:

If the methods of change pay-out (previous paragraph) includes the return of one or more notes, the cashier or a cash recycler typically will give or provide the notes to the customer.

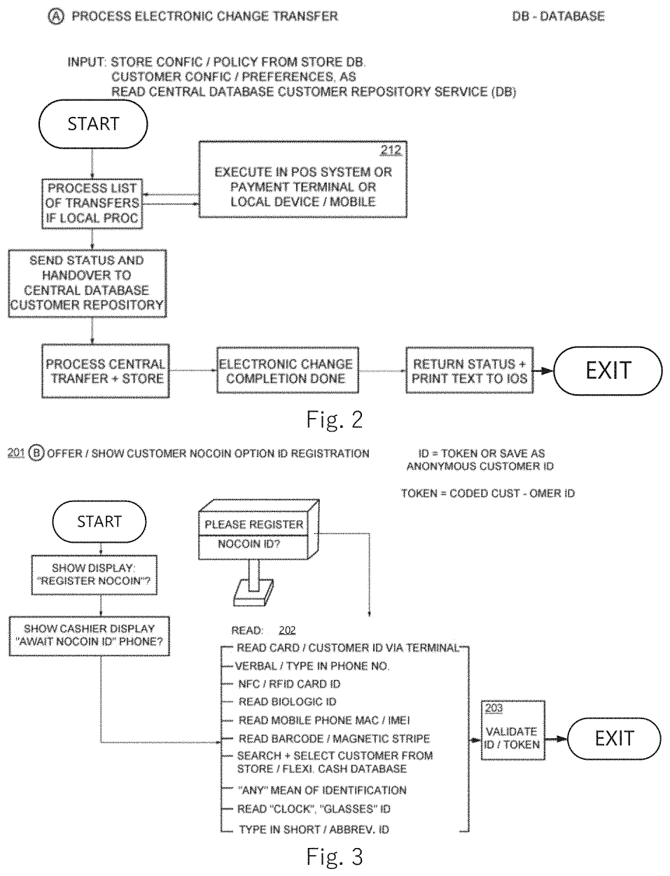

Process Electronic change transfer using APP, Central Database Customer Repository and/or Payment terminal (FIG. 2, 212):

To ensure pay-out to the customer by electronic means the POS system will further process the list of pay-out methods and use a payment terminal, a connected device, wireless devices or other local means to transfer the change amount in full or partial from the merchant holdings to the customer holdings, or other holdings that the customer has listed in its list of preferred pay-out targets.

When any locally (POS based) transfers have been processed the POS will send the status of the operations performed and request the central Database Customer Repository service to process any pay-outs and operations that are to be performed centrally.

When the central processing has been completed, the central service return the processing status to the POS system, optionally together with a printable text documenting the operations and confirmations needed on the customer receipt.

Complete Sale+Print 213:

The POS system will when getting the returned status back typically be able to commit or rollback the sale and any transactions involved. When committed the sale is closed and a receipt may be produced. This completes the POS sale+payment process.

When a purchase is due to be paid, the point of sale (POS) system will transfer the amount due to the payment terminal or the cashier (receiver of payment) will enter the amount due into the payment terminal (other devices may apply) manually.

The customer will then insert or activate the payment method (card, mobile etc.) and allow the payment terminal to read the customer identification through the payment method identification. Then, the customer will typically enter a pin code or provide other means to confirm his or her personal identity.

The payment terminal (app, device, etc.) will then check the identity from the information provided. This step may involve contacting central servers/resources for the confirmation. If the identity is confirmed a payment request is sent from the payment terminal to the payment gateway/processor, that will ensure that the payment can be completed by checking with the holdings linked to the customer via a bank or other sources.

The above payment process as described is simplified and the actual process can be different.

An approved payment results in the payment terminal sending an “OK” message back to the POS system, or the payment terminal shows the result on its display and possible an attached printer. The POS system will either read the payment status from the payment terminal, or the cashier will input the payment ok status manually, whereby the sale is completed.

If the payment is declined for some reason this result is returned to the payment terminal, app, other devices, etc. and will be shown on the payment terminal display (i.e.), possibly an attached printer and also it's sent back to the POS system. The POS system may then not complete the sale as-is and the customer may get this information verbally from the cashier.

In effect, the payment request in current systems only has two possible outcomes; Accepted or Denied. Still the reason for Denied may also be due to other reasons than limited funds, such as technical problems, communication problems etc.

According to the present invention a situation where a purchase is due to be paid, the customer will be asked to pay by cash or insert a card or activate another payment method by other means (NFC, card, ID number, fingerprint, mobile app etc.) to allow the payment system to read the customer identification through the payment method identification. At some stage during the card insert/registration, the customer will typically enter a pin code, leave a fingerprint verification etc. or provide other means to confirm his or her personal identity. This identification can be for example a one-phase or a two phase identification method.

The payment terminal or other device/system/app will then check the identity and correctness of a (ie.) pin code from the information provided, like for example with the card issuer. This step may involve contacting central issuer/PSP servers/resources for the confirmation.

When the identity is read from the payment method/card issuer (typically by using a token=an anonymized ID value) the payment terminal will send the customer token/id to the POS system or other store systems to confirm the known customer identity, where the systems may perform pre-payment operations like checking the store internal databases and customer information system for relevant customer data. This in order to determine the type of payment preferred, supported alternative payment options and services relevant to the payment process. During this process the customer identity will also be sent to a Central Database Customer Repository Token/ID matching central to retrieve a list of available payment options and other profile/preference information valid for the specific customer.

The Central Database Customer Repository Token/ID matching central holds Token/IDs linked to a specific customer that has registered one or more Token/IDs with the central. The registration of a Token/ID may take place using the payment terminal, app or other devices or by using the POS system or by having the customer making a registration to be active with stores and payment system providers. Each Token/ID stored typically represent one or more customer to payment or store relationship(s).

The Central Database Customer Repository Token/ID matching process may also be run with selected stores and/or payment service providers independent from any centralized Central Database Customer Repository Token/ID matching central. As a result, the Token/ID matching may fully or in partial be separate from a Central Database Customer Repository Token/ID central. Either or both as mentioned is possible.

The communication with any off-premises (external) information systems and any internal back-office or database systems may take place directly from the payment terminal and/or from the POS/store system and/or by using other means/devices connected to the payment terminal and/or POS system, in order to complete the information retrieve process.

From the identification and Central Database Customer Repository Token/ID matching process, the data returned from this the POS/other store system (or the payment terminal if this is controlling the process) will learn which payment options are available to the customer and in which order these may or must to be applied. Such payment options may offered based on payment availability or business related preferences.

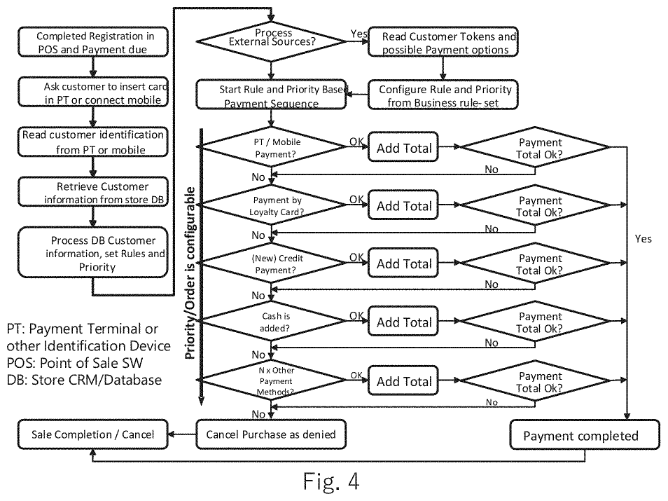

Such a list may be for example Ref FIG. 4:
1. Bank debit card available
2. Visa credit card available
3. Existing Credit balance may be used
4. Other linked accounts
5. A new Credit may be offered as an credit/small loan
6. Loyalty points available
7. Loyalty balance available

All, or some of the above list of available payment options may be collected after an initial debit/credit using a primary card has been attempted and then been declined or other controlled situations dictate the inclusion of different payment methods and sources.

Based on this information the POS/store system (or the payment terminal, app, device directly if it is controlling the process) will attempt the operations in sequence to ensure that a complete payment may be completed. Most often, this will include one single charge to a debit/credit card and no other operations may be required. Still a mix of payment methods can be applied based on the rules set in the different profiles and information systems.

Using the example, if a bank debit and Visa credit charge both fails (may be same account in fact) a request is sent to a Credit system (without giving customer notification), with the customer Token/ID and the purpose of the purchase and the amount involved. This is then processed by the Credit system in real-time and the response may for example be positive, negative or conditional.

These are three examples of credit system responses:
1. Declined
   i. No amount may be paid on behalf of the customer.
2. Accept
   i. The amount can be accepted to be paid by credit system, by using the customer existing credit limit/balance.
   ii. Conditions like an interest rate, change to monthly payments etc. may be added together with documents like a loan/credit contract
3. Conditional
   i. The amount exceeds to available balance/limit, but an alternative lower amount as specified may be approved
   ii. Conditions like the interest rate, change to monthly payments etc. may be added together with documents like a loan/credit contract

The POS/store system and payment terminal will then notify the customer that the primary account balance is low, but that the payment may still be completed using the customer existing credit system. The customer may then choose to accept the credit charge, or decline the offer.

If the offer is accepted a new identity verification (manual or using pin code) may be required by the customer and if needed a paper based contract/information may be printed and if needed signed by the customer.

If the offer is declined by the customer the POS system and payment terminal may either cancel the full sale as-is, or allow a next (if any) payment options to be tried and if successful offered to the customer.

The POS/store (=merchant) system may also provide the list of payment options to the customer, and allow the customer to choose (or attempt) the preferred alternative payment method.

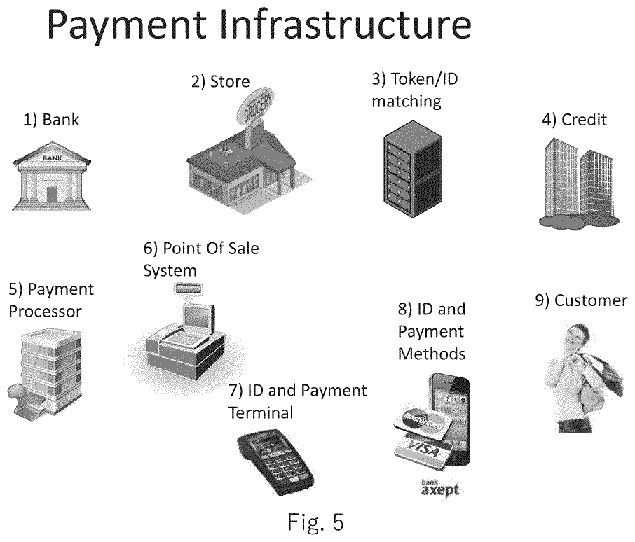

Below is a sample sequence of operations where a credit card/account campaign is preferred for some customers. The reference numbers correspond with those in FIG. 5. The process is an example and some of the steps involved may be more complex in a real-world system and scenario.

A customer 9 wants to purchase of a new watch in a jeweler store 2. The cashier operating the POS/store/merchant system 6 will register the item in the POS system (app++) 6 and prepare the POS system 6 for the payment part. When the customer is ready to pay he/she is asked by the cashier operating the POS system 6 if he/she would like to pay with cash or a card 8 or use other payment methods 8.

The customer 9 responds by inserting a debit card 8 into the payment terminal 7. The payment terminal 7 then sends a request to check the card 8 validity to the bank (card issuer) 1, where the bank 1 typically will confirm that the card 8 is valid.

The payment terminal 7 will then request the customer 9 to verify his/her identity by entering a pin code on the payment terminal 7. The pin code is entered into the payment terminal 7 by the customer 9 and then the payment terminal 7 checks the pin code using its secure hardware against the card 8 information. If the verification succeeds the payment terminal 7 will send a message to the POS system 6 with the customer ID (i.e. Token) to inform that a valid payment card 8 and a verified customer 9 is present and ready to be charged/processed.

The POS system 6 will then request the store 2 system database and backend system for customer specific information (i.e. CRM system) and how the POS system 6 is to perform the payment process. For this example the POS system 6 is told to process the customer 9 in speak as follows:
1. Offer this customer 9 an interest free, 30 day credit of $1000 offered by a credit provider 4 to complete the purchase, where $299 is charged directly to pay for the watch
2. If the customer 9 declines the offer, use the present debit/credit card 8 to charge the account
3. If the card 8 charge operation fails, allow the customer to pay using store specific loyalty points available.
4. If all of the above fails and/or are declined cancel the sale and payment in full

If the customer 9 accepts the 30 day interest free credit offer from the credit provider 4, a verification process is initiated as follows:

The POS system 6 (or payment terminal 7) sends a credit request on behalf of the customer 9 to the credit provider 4. The credit provider 4 checks the customer 9 financials and metrics in real-time and approves or declines the credit request by sending a response to the POS system 6 (or payment terminal 7). In the case of an approval the POS system 6/payment terminal 7 will give the customer 9 the option to accept the credit offer. Assuming the customer 9 accepts the offer an agreement/account is created by the credit provider 4 and then the payment amount due is transferred from the credit provider 4 to the store 2 banking partner 1. The transfer of the payment funds from the credit provider 4 to the store 2 may also be settled using invoicing or other means typically used to settle the balance between different business partners.

Optionally additional steps may be performed to ensure the credit agreement is entered using the needed signatures and documentation.

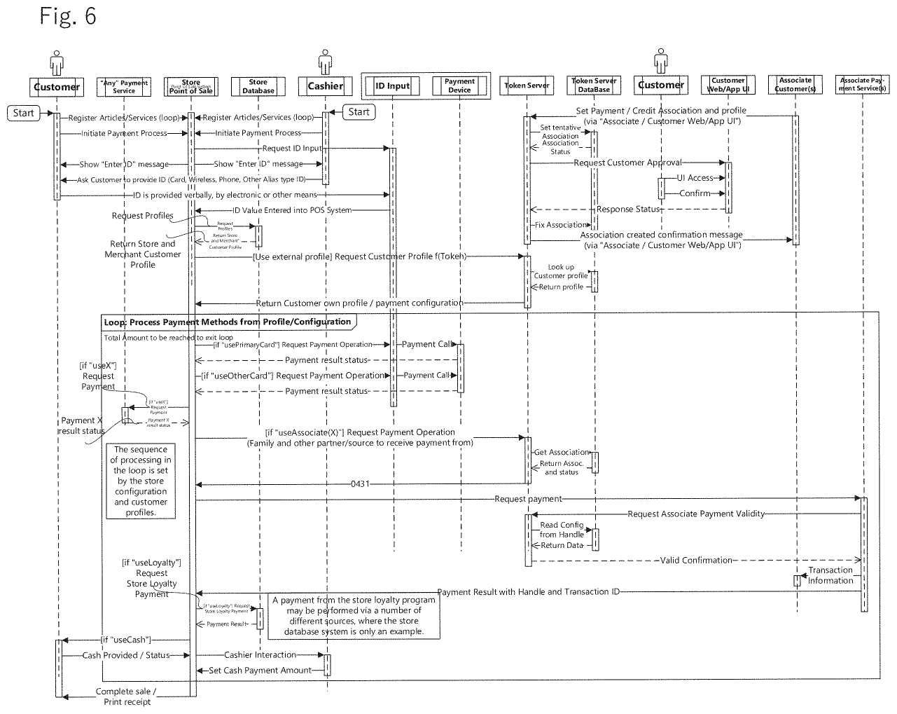

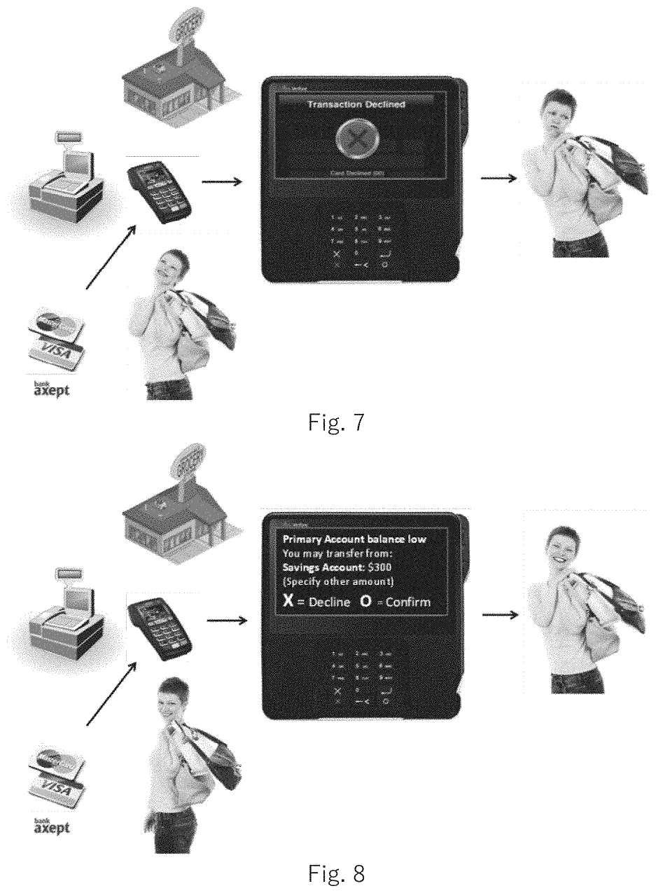

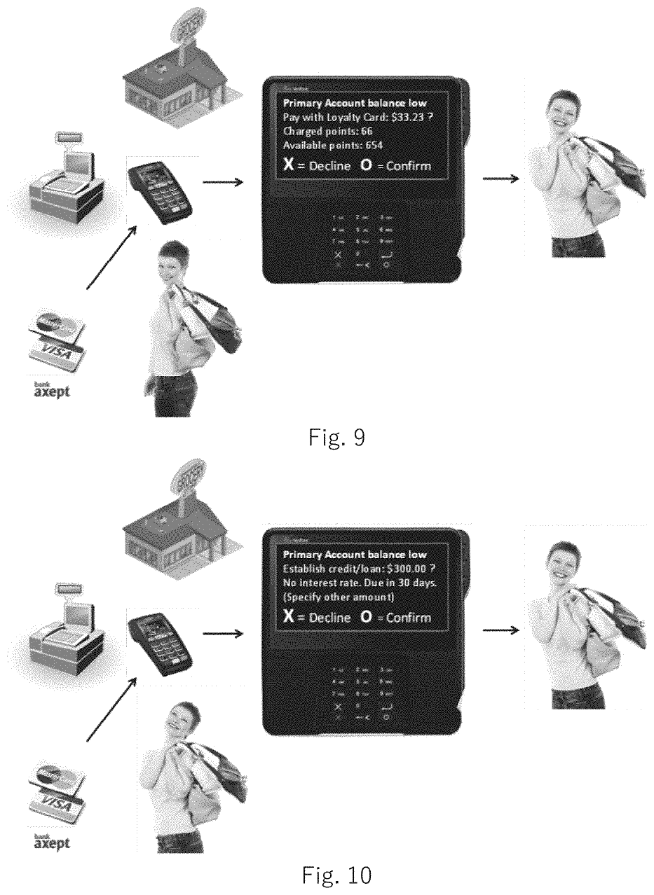

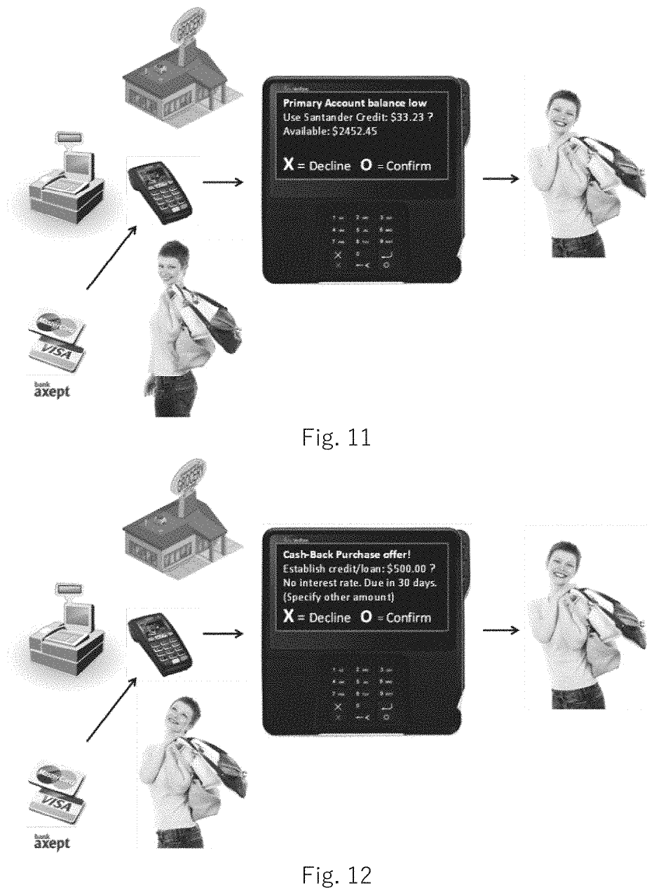

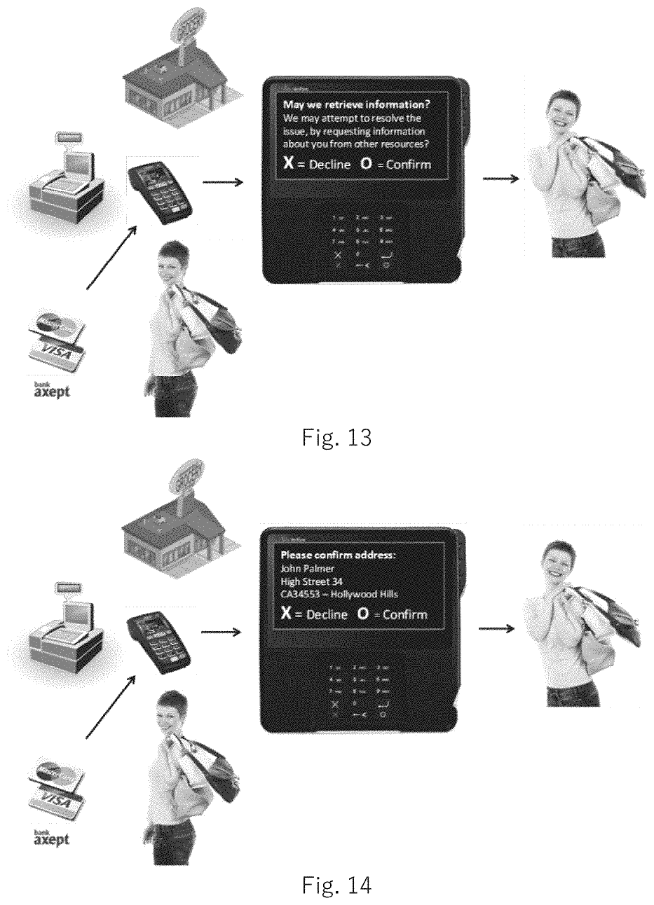

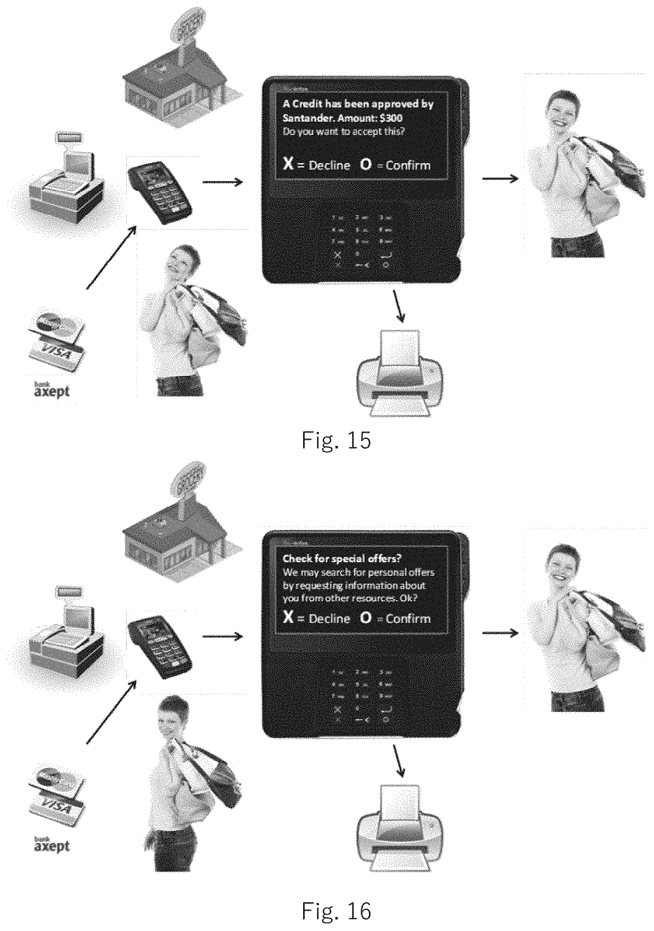

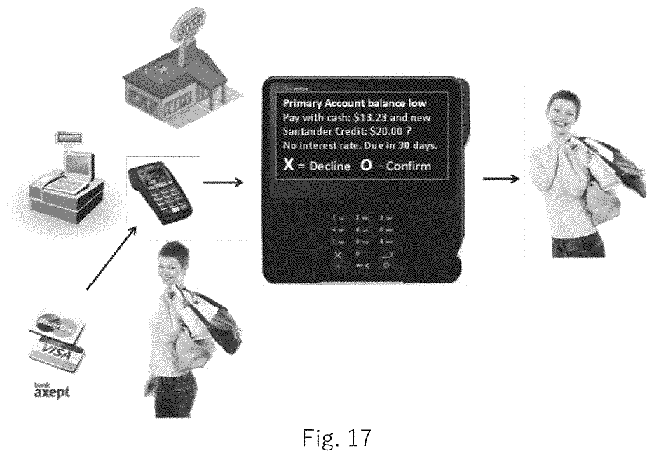

A detailed sequence diagram is disclosed in FIG. 6. The sequence diagram shows interactions between elements in a transaction system for transactions. At the top of the figure the involved elements are shown whilst the sequences between elements is shown as lines/arrows between elements.

The ID Input can be an element in a payment terminal; however, it can also be a stand-alone unit, which is associated with the POS. In the event that it is a stand-alone unit it can exchange data through a protocol with the POS, however it may also exchange data through a protocol directly with a token server. A stand-alone ID Input can be an RFID reader, a scanner, an NFC reader, a Bluetooth receiver or a WiFi transceiver. An RFID reader can be used to read an RFID tag held by a customer that identifies the customer. A scanner can be used to read ID card of a customer or to read other credentials particular to the customer, which identifies the customer. An NFC transceiver can be used for data exchange between an NFC communication device associated with a customer, which identifies the customer, and the stand-alone ID Input unit. An NFC communication device can be included in a cell phone belonging to the customer, but it can also be included in wearables of the customer. Similarly, a Bluetooth communication device or a WiFi transceiver can be included in a cell phone belonging to the customer, but it can also be included in wearables of the customer.

It shall be noted that a two-phase identification as well as two-factor identification of customers can be effectuated in an embodiment of the present transaction system. By two phase identification it is meant that a customer in addition to showing his ID with one of the means indicated above he or she shall also authenticate ownership of the ID means by for example typing a PIN code, a Password or the like on a Payment terminal or a stand-alone ID Input unit. Signatures and biometrics can also be used in a two-phase system for verification of shown identity.

It can be instances when additional security is necessary in the event of a transaction, for example if a loan is negotiated and granted. In such instances, a two-factor system for identification and authentication of the customer may be used. A two-factor system is a system where the customer has two independent devices, which is associated with the customer. In one example, a first device can be an identity card and the second device can be a cell phone. A scenario can be as follows, a customer identifies himself on a payment terminal or on a stand-alone ID Input reader with a bankcard. If the data exchange between the card reader and a receiver such as a token server or a POS is OK, a second step is initiated where a text message is pushed to the customers cell phone, the text message invites the customer to verify his identity or the transaction between the first factor and the reader of the payment terminal or the stand alone ID Input unit. The two-factor method indicated is an example and other two factor means can be employed in a transaction system according to the present invention.

It shall be noted that devices belonging to a customer such as cell phones carries unique identifiers such as IMEI codes, MAC addresses, SEID etc. that in a secure manner identifies one factor in an ID-process, however in a one-phase system the association between the first factor and a customer is not verified. Two-phase systems verifies this association whilst two factor systems further increases transaction security.

In the context of this patent application it shall be appreciated that the notion “Payment terminal ID Input” shall include “ID Input stand-alone units” such as those mentioned above.

Reference numerals

| | |
|---|---|
| 1 | Bank |
| 2 | Store |
| 3 | Token/ID matching |
| 4 | Credit |
| 5 | Payment processor |
| 6 | Point of sale system, POS |
| 7 | ID and payment terminal |
| 8 | ID and payment methods |
| 9 | Customer |
| POS | A point of sale is the time and place where a retail transaction is |
| | completed. At the point of sale, the merchant calculates the |
| | amount owed by the customer, indicates that amount, may |
| | prepare an invoice for the customer, and indicates the options for |
| | the customer to make payment. It is also the point at which a |
| | customer makes a payment to the merchant in exchange for |
| | goods or after provision of a service. After receiving payment, the |
| | merchant may issue a receipt for the transaction, which is usually |
| | printed but is increasingly being dispensed with or sent |
| | electronically. |
| CRM | Cash Recycler Machine |
| RFID | Radio Frequency Identity |
| NFC | Near Field Communication |
| WiFi | Wireless local area networking of devices based on one or more of |
| | the IEEE 802.11 standards. |
| SEID | Secure Element Identifier for secure transactions a SEID is |
| | commonly found in NFC enabled devices. |
| ID | Identification, i.e. identification information for one or more |
| | customers, interning to purchase goods in a retail store. |

1. Commodity trade value transaction system, at least comprising:
a) one or more POS-systems in a retail store,
b) one or more payment terminals in the retail store, at least configured to communicate with the one or more POS-systems,
c) means of payment held by a customer,
d) reading means embedded in the one or more payment terminals in the retail store configured to read means of payment data and optionally means of payment holder data,
e) at least one customer data base,
f) a first processor with processing means and memories, included in the POS, for process of payment data associated with payment data holder and customer data, where the customer data is mapped with payment data holders,
g) a first set rules algorithm run by the first processor,
h) a first decision machine configured to receive first set rules output of first set rules algorithm and further configured to, based on received data, decide further transaction sequences,
i) at least one token/ID-matching server, configured to hold customer data,
j) at least one second processor included in the token/ID-matching server configured to execute a second set rules algorithm,
k) a configurator of the token/ID-matching server is configured to receive output from the second set rules algorithm and based on the received output from the second set rules algorithm to configure further transaction steps,
l) an execution machine configured to interface with the configurator and execute further transaction steps based on the output from the configurator,
m) the execution machine includes at least one second decision machine configured to receive further execution steps from the configurator and configured to receive input data from the customer and further configured to, based on input, to make a choice for means of payment for concluding a commodity value transaction.

2. A commodity trade value transaction method at least comprising the steps of:
a) initialising the commodity trade value transaction method at completed registration of commodities to be purchased by a first customer, the initialisation is initiated by:
i. the first customer communicates a payment process request to a point of sale, POS, or
ii. a cashier communicates a payment process request to the POS, and
b) the POS initialises an ID step for identification of the first customer,
c) the POS initialises a profile acquisition step, acquiring profile data of the first customer,
d) the POS initialises a payment process where acquired profile data of the first customer together with the final amount due for the commodities to be purchased by the first customer is used as input parameters for the payment process, and
e) the POS initiates a complete sale step.

3. A method according to claim 2, where the ID step for identification of the first customer further at least comprises the sub steps bi and by of the sub steps bi to by:
bi) POS forwards a Request ID Input message to a payment terminal ID Input;
bii) POS simultaneously or substantially simultaneously forwards a message to the customer with a message which invites the customer to show his identity and a message is forwarded to the cashier with a message that invites the customer to show his identity;
biii) the cashier invites the customer to show his identity;
biv) the customer shows his identity to the payment terminal ID Input;
bv) the payment terminal ID Input sends an ID value to the POS, hence the customer identity becomes known to the POS.

4. A method according to claim 2, where the ID step for identification of the first customer further at least comprises the sub steps
from the POS simultaneously or substantially simultaneously forward a push message to a display screen visible to the first customer with a message that invites the customer to show his identity and a push message is forwarded to a display screen visible to the cashier with a message that invites the customer to show his identity.

5. A method according to claim 3 where step biv at least includes one of the following steps:
the customer initiates a data exchange between data holding circuitry on a customer bank card and the payment terminal ID Input;
the customer initiates a data exchange between customers mobile phone and the payment terminal ID Input;
the customer initiates a data exchange between data holding circuitry on a customer identity card and the payment terminal ID Input,
and
the customer identifies himself manually to the cashier; the cashier enters the customer personalia into the POS.

6. A method according to claim 5, where the payment terminal ID Input is a stand-alone ID Input device.

7. A method according to claim 2, where the profile acquisition step acquiring profile data of the first customer further comprises the sub steps of:
ci) at the POS generate a request for customer profiles message;
cii) from the POS forward the request for customer profiles message to a store database holding customer profile registries;
ciii) from the store database generate a customer profile message;
civ) from the store database forward the generated customer profile message to POS;
cv) from the POS generate and send a request for customer profile to a token server;
cvi) at the token server generate a customer profile/payment configuration message;
cvii) at the token server forward the customer profile/payment configuration message to the POS, thereby acquiring profile data of the first customer to the POS.

8. A method according to claim 7 where the step ciii) further includes the foregoing step of: at the store database look up match between payload of received customer profile message and registry entries, if match=true, then generate a customer profile message based on content of matched registry entry.

9. A method according to claim 7 where the step cvi) further includes the foregoing step of: at the token server look up match between payload of received customer profile message received from POS and registry entries in a token server database, if match=true, then generate a customer profile message based on content of matched registry entry in the token server database and from the token server database return the generated customer profile to the token server and continue with sub step of at the POS storing the updated payload in a memory associated with the POS.

10. A method according to claim 2, where the payment process of step d) further comprises the sub steps of:
di) at the POS generate a payment request message, the payment request message at least including:
invitation to the customer for use of highest priority payment means,
a counter value n=0
the amount due to be paid=Sₙ₊₁
Nₙ₊₁=indicator of payment means and its priority number, where N₁ is highest priority payment means,
the number of payment means available to the customer: NA;
dii) from the POS forward the payment request message to the payment terminal ID Input;
diii) from the payment terminal ID Input the payment request is forwarded as a payment call to a payment device of the payment terminal;
div) at the payment device of the payment terminal send a request to the customer to accept payment means Nₙ₊₁, if request is not accepted continue at step dviii);
dv) at the payment device of the payment terminal generate a payment result status message based on at least one of the tests T1 and T2:
T1: is Aₙ₊₁≥Sₙ₊₁;
T2: is n+1=NA;
Pₙ₊₁=Aₙ₊₁ if T1=false
Pₙ₊₁=Sₙ₊₁ if T1=true
where: Aₙ₊₁=available amount on payment means Nₙ₊₁;
Pn+1 is amount to be reserved on payment means Nₙ₊₁
generate a payment result status message with a payload, where the payload at least include:
the logical value of T1 and T2;
the amount reserved, Pₙ₊₁, for later debiting of the payment means;
values of Aₙ₊₁, Sₙ₊₁ and NA, and
priority number of payment means Nₙ₊₁;
dvi) from the payment device of the payment terminal forward the generated payment result status message including the payload to the POS;
dvii) at the POS analysing the payment result status:
if T1=“true” AND T2=“X” then continue with sub step dx
if T1=“false” and T2 is “true” then continue with sub step dix);
dviii) at the POS generate a payment request message with updated payload where the updated payload of the payment request message at least includes:
an updated new counter value: n=n−1
invitation to the customer for use of a lower priority than previously ranked payment means, Nₙ₊₁,
an updated amount due to be paid: calculate remaining amount due to be paid: Sₙ₊₁=Sₙ−Pₙ and include the remaining amount due to be paid in the payment request message, then continue with sub step dii);
dix) cashier invites the customer to use cash to settle the remaining amount due to be paid or the POS cancels the commodity trade value transaction and finishes the payment process;
dx) at the POS finishing the payment process.

11. A method according to claim 10, where the step div) further includes the foregoing step of: at the payment device receiving the payment request and forwarding to a display means associated with the payment device an input request to the customer where the input request includes the payment means priority number Nₙ₊₁ and a request to choose or not choose the payment means with the priority number Nₙ₊₁.

12. A method according to claim 10, where the step dv) further includes the subsequent step of: storing the generated payment result status message with the payload in a memory associated with the payment device.

13. A method according to claim 10, where the step dvii) further includes the foregoing step of: at the POS receiving and storing the received payment result status message with the payload in a memory associated with the POS.

14. A method according to claim 10, where the step dviii) further includes the step of: at the POS storing the updated payload in a memory associated with the POS.
